(19) United States
(12) Patent Application Publication
(10) Pub. No.: US 2005/0055377 A1
(43) Pub. Date: Mar. 10, 2005

(54) User interface for composing multi-media presentations

(76) Inventors: Richard J. Dorey, Bellevue, WA (US); Gordon Powers, Bellevue, WA (US)

Correspondence Address: Mark L. Lorbiecki, Esq.;BLACK LOWE & GRAHAM PLLC, Suite 4800, 701 Fifth Avenue, Seattle, WA, 98104, US

(21) Appl. No.: 10/854,461

(22) Filed: May 26, 2004

Related U.S. Application Data
(60) Provisional application No. 60/500,367, filed on Sep. 4, 2003.
(60) Provisional application No. 60/500,365, filed on Sep. 4, 2003.
(60) Provisional application No. 60/500,203, filed on Sep. 4, 2003.
(60) Provisional application No. 60/564,796, filed on Apr. 23, 2004.

(51) Int. Cl. G06F 17/00

(52) U.S. Cl. 707/104.1

(57) ABSTRACT

A method, distributed computer system, and computer software program, stored on a computer readable medium, is configured to generate multimedia presentations. The program includes a database management system. The database management system includes audiovisual content stored in association with icons indicative of the audiovisual content and a memory buffer for storing a multimedia presentation. The memory buffer is configured to store media content in association with an exhibition time within the multimedia presentation. A server stub is configured for storing and recalling data in the database management system in accord with requests for actions received at the server stub from the client computer. The stub also generates messages to the client computer indicative of the media content stored in the memory buffer. A compiler, the compiler is configured to generate a file including the multimedia presentation stored in the memory buffer.

### PRIORITY CLAIM

This application claims priority from several provisional applications filed descriptive of the inventive subject matter. By this reference, these provisional applications are incorporated herein; the provisional applications being first entitled, “PATENT IDEAS,” filed on Sep. 4, 2003 and bearing Ser. No. 60/500,367, Attorney Docket No. OTDM-1-1001; the second entitled “COPYRIGHT AND INTELLECTUAL PROPERTY FEES COLLECTION MUSIC PROMOTION AND ROYALTY MONEY COLLECTION,” filed on Sep. 4, 2003, and bearing the Ser. No. 60/500,365, Attorney Docket No. OTDM-1-1002, the third entitled “SHOCKWAVE FLASH FILE SEGMENTATION,” filed on Sep. 4, 2003 and bearing the Ser. No. 60/500,203, Attorney Docket No. OTDM-1-1003; and finally entitled “SHOCKWAVE FLASH FILE SEGMENTATION,” filed on Apr. 23, 2004 and bearing the Ser. No. 60/564,796, Attorney Docket No. OTDM-1-1004.

### FIELD OF INVENTION

This invention relates generally to composing multimedia presentations and, more specifically, to User Interfaces for Composing Multi-Media Presentations.

### BACKGROUND OF THE INVENTION

The full use of the Internet has been limited by the inability of users to easily convert ideas into multi-media presentations. Such solutions as technology has offered have not enabled the user to readily transform a group of elements such as music clips, art, and voice snippets into a readily playable program. For instance, while one might be able to simply produce a presentation on video tape by standard filmmaking techniques and then, in turn, convert the video content into a streamable video signal.

Among the short-comings of a file resulting from converting of a video taped presentation would be a single segment, with no ability to interact with the content of the file by allowing the user to select such of the content the user wishes to view. As a single, unsegmented file, the content would only be viewable as a whole and any errors in transmission would prevent the viewing of the content. Additionally, the file would be savable by a third-party who might use the file in a manner not intended by the author of the presentation.

What is needed, then, in the art, is a method, a computer software program, and a processor configured to assemble multimedia file content that is intuitive, straightforward, and configured to preserve protection of the assembled material.

### SUMMARY OF THE INVENTION

The present invention comprises a method, a computer software program, and a server-resident database for composing multimedia presentations. Because much of the actual data manipulation is resident on the server rather than on the client machines, it can facilitate interaction with either Macintosh or Personal Computer clients. Additionally, the client software can be kept up to date by interaction with the server software.

In accordance with further aspects of the invention, the invention is not dependant upon a common browser and therefore is not susceptible to hacking. Because the communication between the server and the client software is not the transfer of executable files, but the synchronization of data according to a graphic user interface in the client software, the exchange of information between the server and the client software will not propagate virus software. Additionally, once a user begins a session, the client software is updated to display data icons consistent with the locations of data on the server database. Thus, if a user opens a session on the user's home computer and then, in mid-session must leave for work, the user may continue the session on a distinct computer, such as the user's work computer or a computer available at a public kiosk without the loss of either privacy or data.

In accordance with other aspects of the invention, the client software uses a very intuitive graphic user interface to convey information as to data locations on the server. Thus, the client software, when resident on a client computer, takes up relatively little space and can be run on processors with limited power. Thus, where displays allow, clients could be configured for smaller computing devices such as handheld and palmtop computers, cellular telephones, and kiosks configured for public use. Dedicated machines for presentation description could be constructed for little cost. These dedicated machines would allow persons not skilled with computers to rapidly and frequently construct presentations that, by necessity, portray time sensitive materials, such as sales presentations for real estate or automobiles.

In accordance with still further aspects of the invention, the invention may be used as a means to sell copyright protected media content without risk of secondary propagation. The server is configured to handle the data until the moment that the multimedia presentation is generated as a series of Shockwave Flash data files. Until then, the user, on client software, manipulates low-resolution iconic representations of picture data, and icon place holders for sound to compose the program. The program can be streamed to user for viewing without giving the user control of the presentation until a moment where the server facilitates the purchase of a license for the media content. The streaming security is known in the art, and most Internet browsers are equipped to display Shockwave Flash movies without leaving a usable copy of the presentation on the displaying client computer.

In accordance with yet other aspects of the invention, the interactions between the client and the server are not easily “hacked.” Because the designation of remote procedure calls can be unique to the software with no diminution of the efficacy of the software, hackers cannot readily observe eavesdrop on the interchange between client and server. Encryption of actual data that passes between the client and server further strengthens security during the data interchange. Any encryption scheme may be interposed between the client and server as the data is BLOB or “binary large object” to which most encryption schemes are configured.

As will be readily appreciated from the foregoing summary, the invention provides a method, distributed computer system, and computer software program, stored on a computer readable medium, configured to generate multimedia presentations. The program includes a database management system. The database management system includes audiovisual content stored in association with icons indicative of the audiovisual content and a memory buffer for storing a multimedia presentation. The memory buffer is configured to store media content in association with an exhibition time within the multimedia presentation. A server stub is configured for storing and recalling data in the database management system in accord with requests for actions received at the server stub from the client computer. The stub also generates messages to the client computer indicative of the media content stored in the memory buffer. A compiler, the compiler is configured to generate a file including the multimedia presentation stored in the memory buffer.

### BRIEF DESCRIPTION OF THE DRAWINGS

The preferred and alternative embodiments of the present invention are described in detail below with reference to the following drawings.

FIG. 1 is a block diagram of a distributed network system configured to support the method and computer software of the invention;

FIG. 2 is a block diagram of a typical computer configured to run the computer software program in question;

FIG. 3, is a block diagram of a distributed network for composing multimedia presentations;

FIG. 4 is a block diagram of a server software embodiment of the inventive system;

FIG. 5 is a graphic depiction of a process of dividing multimedia content into segmented files;

FIG. 6 is block detail diagram of the connection between the client and server software over a network;

FIG. 7 is an exemplary screenshot of the inventive software depicting the graphic representation of media content in two buffers; and,

FIG. 8 is a flowchart for an embodiment of the inventive method of generation a multimedia presentation.

### DETAILED DESCRIPTION OF THE PREFERRED EMBODIMENT

By way of overview, a method, distributed computer system, and computer software program, stored on a computer readable medium, is configured to generate multimedia presentations. The program includes a database management system. The database management system includes audiovisual content stored in association with icons indicative of the audiovisual content and a memory buffer for storing a multimedia presentation. The memory buffer is configured to store media content in association with an exhibition time within the multimedia presentation. A server stub is configured for storing and recalling data in the database management system in accord with requests for actions received at the server stub from the client computer. The stub also generates messages to the client computer indicative of the media content stored in the memory buffer. A compiler, the compiler is configured to generate a file including the multimedia presentation stored in the memory buffer.

The following discussion is intended to provide a general description of a suitable computing environment in which the invention may be implemented. While the invention will be described in the general context of an application program that runs on an operating system in conjunction with a personal computer and in connection with a server, those skilled in the art will recognize that the invention also may be implemented in combination with other program modules. Generally, program modules include routines, operating systems, application programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote memory storage devices. Execution of the program modules may occur locally in a stand-alone manner or remotely in a client/server manner. Examples of such distributed computing environments include local area networks of an office, enterprise-wide computer networks, and the Internet.

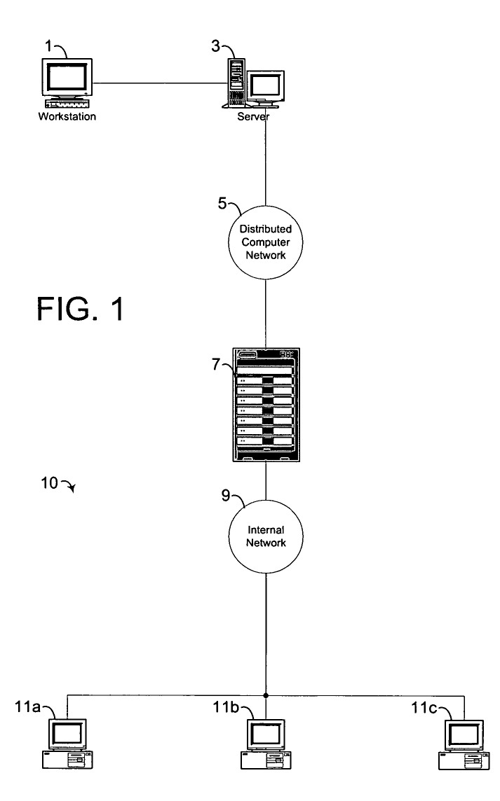

FIG. 1 illustrates a typical client-server environment 10 in which an exemplary embodiment of the present invention operates. A computer system or client 1, such as a conventional personal computer or any device operable to communicate over a network, is connected to an Internet server computer 3 (“server”). The server 3 is generally provided by an Internet service provider (ISP), which provides Internet access for a typical Internet user. The server 3 is connected to a distributed computer network 5, such as the Internet or a wide-area network (“WAN”), and enables the client 1 to communicate via the distributed computer network 5.

The client 1 communicates via the combination of the server 3 and the distributed computer network 5 to a server 7, such as a communication or an e-mail server. In an exemplary embodiment, servers 3 and 7 support e-mail services, contain a message store for holding messages until delivery, and contain a translation facility or gateway for allowing users having different e-mail programs to exchange mail. The server 7 is connected to an internal network 9, such as a local-area network (“LAN”) and enables the client 1 to communicate with the clients 11a, 11b, and 11c via the internal network 9.

The clients 11a, 11b, and 11c are not only able to respond to a communication from the client 1, but are also able to initiate communication with the client 1. The clients 11a, 11b, and 11c can send information via the internal network 9 to the server 7. The server 7, in turn, forwards the information to the client 1 via the distributed computer network 5. The information is retrieved by the server 3 and can be forwarded to the client 1, when requested by the client 1.

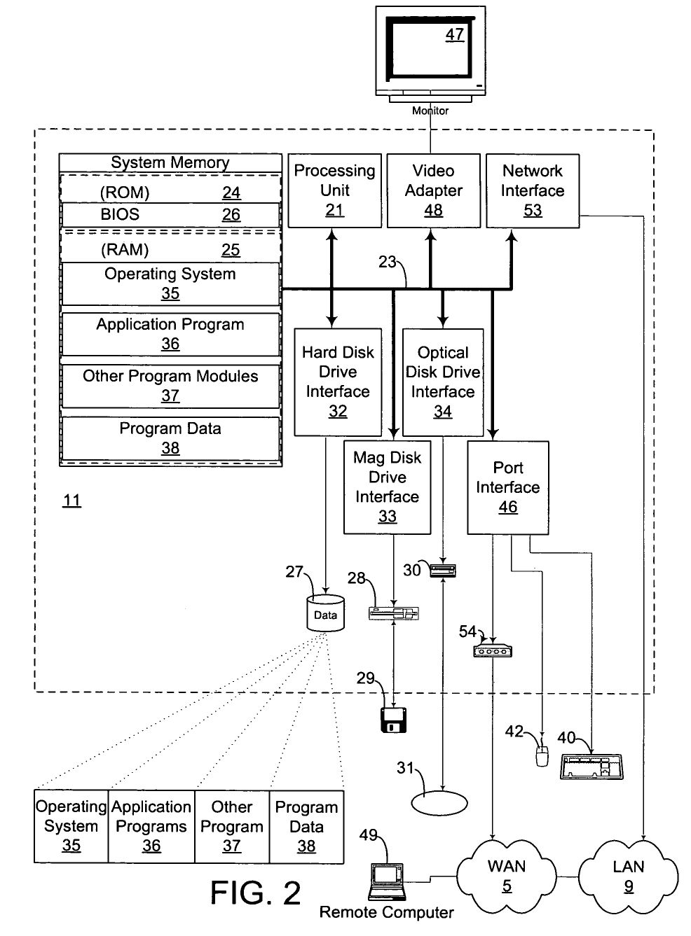

With reference to FIG. 2, an exemplary system for implementing the invention includes a conventional personal computer 11, which serves as a client. The client 11 may represent any or all of the clients 1, 11a, 11b, and 11c illustrated in FIG. 1. The client 11 includes a processing unit 21, a system memory 22, and a system bus 23 that couples the system memory to the processing unit 21. The system memory 22 includes read only memory (ROM) 24 and random access memory (RAM) 25. A basic input/output system 26 (BIOS), containing the basic routines that help to transfer information between elements within the client 11, such as during START-up, is stored in ROM 24. The client 11 further includes a hard disk drive 27, a magnetic disk drive 28, e.g., to read from or write to a removable disk 29, and an optical disk drive 30, e.g., for reading a CD-ROM disk 31 or to read from or write to other media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage for the client 11. Although the description of computer-readable media above refers to a hard disk, a removable magnetic disk and a CD-ROM disk, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 25, including an operating system 35, one or more application programs, such as an e-mail program module 36, other program modules, such as a message manager program module 37, a local message store 38, and a database 39 for supporting e-mail applications. A user may enter commands and information into the client 11 through a keyboard 40 and pointing device, such as a mouse 42. Other input devices (not shown) may include a pen, touch-operated device, microphone, joystick, game pad, satellite dish, scanner, or the like. These and other input devices are often connected to the processing unit 21 through a port interface 46 that is coupled to the system bus, but may be connected by other interfaces, such as a serial port, game port or a universal serial bus (USB). A monitor 47 or other type of display device is also connected to the system bus 23 via an interface, such as a video adapter 48. In addition to the monitor, personal computers typically include other peripheral output devices (not shown), such as speakers or printers.

The client 11 operates typically in a networked environment using logical connections to one or more remote computers, such as a remote computer 49. The remote computer 49 may be an e-mail server (which includes one or more message stores), as described above in connection with FIG. 1, a file server (which includes one or more file stores), a router, a peer device or other common network node, and typically includes many or all of the elements described relative to the client 11. The logical connections depicted in FIG. 2 include the local area network (LAN) or the wide area network (WAN) 5. Such networking environments are commonplace in offices, enterprise-wide computer networks, intranets and the Internet.

When used in a LAN networking environment, the client 11 is connected to the LAN 9 through a network interface 53 or additionally through the WAN 5. When used in a WAN networking environment, the client 11 typically includes a modem 54 or other means for establishing communications over the WAN 5, such as the Internet. The modem 54, which may be internal or external, is connected to the system bus 23 via the serial port interface 46. In a networked environment, program modules depicted relative to the client 11, or portions thereof, may be stored in the remote memory storage device. It will be appreciated that the network connections shown are exemplary and other means of establishing a communications link between the computers may be used.

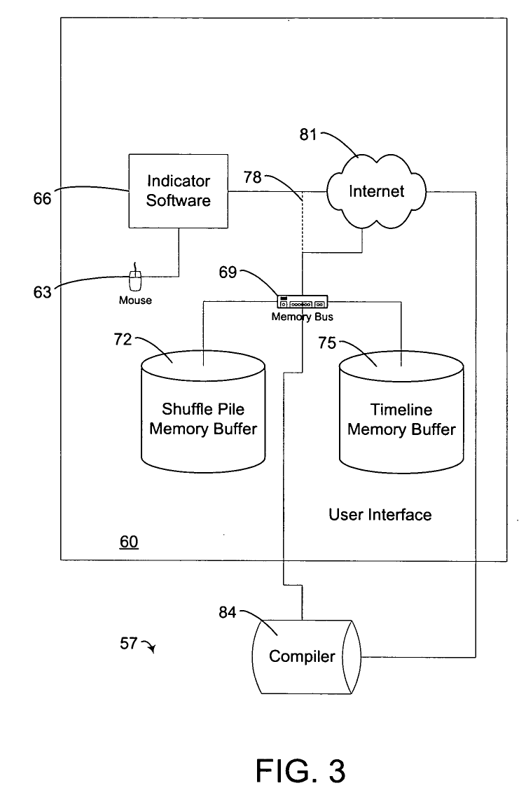

Referring to FIG. 3, a block diagram of a presently preferred embodiment 57 of the invention is depicted. The presently preferred embodiment 57 includes two major components, a user interface 60 configured to control the composition of the multimedia presentation and encompassing an operative linkage between the client 11a, b, or c and the server 3 (FIG. 1) and a compiler 84 for configuring the multimedia presentation in a delivery format, such as the Shockwave Flash format. The user interface 60 includes client or indicator software 66. Optionally, the indicator software is configured as a graphic user interface with any user driven indicator such as the mouse 63 depicted. Those skilled in the art will readily perceive that alternatives to the mouse are known and will readily substitute without substantially changing the practice of the invention.

The compiler 84 configures media content stored in a timeline memory buffer 75 into at least one Shockwave Flash file by retrieving the media content stored in the timeline memory buffer 75 along with such exposition times as are associated with each item of media content. Exposition times or temporal associations are the times assigned to playing a particular item of media content in the finished multimedia presentation as conceived by the user. Thus, for example, if a user wishes to display a still photograph stored in the timeline memory buffer 75 from minute 03:15 to minute 04:10 for a total of 55 seconds, the exposition times associated with the still photograph will be suitably associated with the still photograph in the timeline memory buffer 75, by action of the invention. Configuring a Shockwave Flash file in a compiler 84 to display media at associated exposition times is known in the art and is set forth in the Shockwave Flash (SWF) File Format Specification, now in Version 7 and available from Macromedia, Inc.

It is reasonable to assume that a user will have many of the items media content selected as candidates for inclusion in a multimedia presentation before assigning specific exposition times in the final “draft” of the multimedia presentation. To allow for such items of media content to be present and available to the indicator software 66, a second media memory buffer is provided, a shuffle pile memory buffer 72. The shuffle pile memory buffer 72 is a gathering place for items of media content that will be the “parts” of the assembled multimedia presentation.

In one presently preferred embodiment, a user may place items of media content in the shuffle pile memory buffer 72 from diverse sources. The user might use the indicator software 66 to place the user's own items of media content, such as still photos or voice-over audio sound bites in the shuffle pile from the client computer 11 (FIGS. 1, 2). Additionally, access to media content purchase outlets might be effected to facilitate the purchase of media for placement in the shuffle pile memory buffer 72. In one presently preferred embodiment, the compiler 84 will effect the purchase licenses for the use of copyright protected items of media content upon compiling the Shockwave Flash file, though, by agreement with the copyright holder, that same item of media content may be placed in the shuffle pile memory buffer for “trial fits” in the multimedia presentation without requiring purchase of a license, thereby optimizing the user's purchases without compromising the ability of the user to create a multimedia presentation prior to purchase.

A memory bus 69 is provided and configured to move content from the shuffle pile memory buffer 72 to the timeline memory buffer 75 by creating an association between a selected item of media content and a time of exposition and, further, storing the associated item and time in the timeline memory buffer 75. Advantageously, the memory bus 69 may optionally be used to remove items of media content and the associated exposition time from the timeline memory buffer 75 in the course of composition of a multimedia presentation. In the presently preferred embodiment, the memory bus 69 moves items of media according to instructions from the indicator software 66, the indicator software 66 being in operative communication with the memory bus 69 through either direct connection 78 or over a network such as the Internet 81.

The indicator software 66 is used to interact with the user. In a presently preferred embodiment, it is configured to be a relatively “thin” client, relying upon requested movements and responsive synchronization with a server shuffle pile memory buffer and a timeline memory buffer for its action. In a presently preferred embodiment, the indicator software 66 generates a graphic image depicting a user's workbench. The user's workbench includes a graphic depiction of a desktop containing icons representative of items of media content residing in the shuffle pile memory buffer 72. Additionally, a graphic timeline is depicted to represent the contents of the timeline memory buffer 75. Similar to the icons in the depiction of the media content of the shuffle pile memory buffer 72, icons are depicted on the timeline to represent the association between the items of media content and the associated exposition time. While the presently preferred embodiment is described, a purely local embodiment would use a connection such as optional connection 78 to effect the object of the invention on a single stand-alone computer such as the client computer 11 shown in FIG. 2.

The indicator software 66 provides the sole interaction with the user in the presently preferred embodiment. In one presently preferred embodiment, the user may use an indicator device such as mouse 66, to “drag and drop” media content from the depiction of the shuffle pile memory buffer 72 to the timeline depiction of the timeline memory buffer 75 or to adjust the position of the icon on the timeline depiction to create or to adjust the exposition time associated with the item of media content.

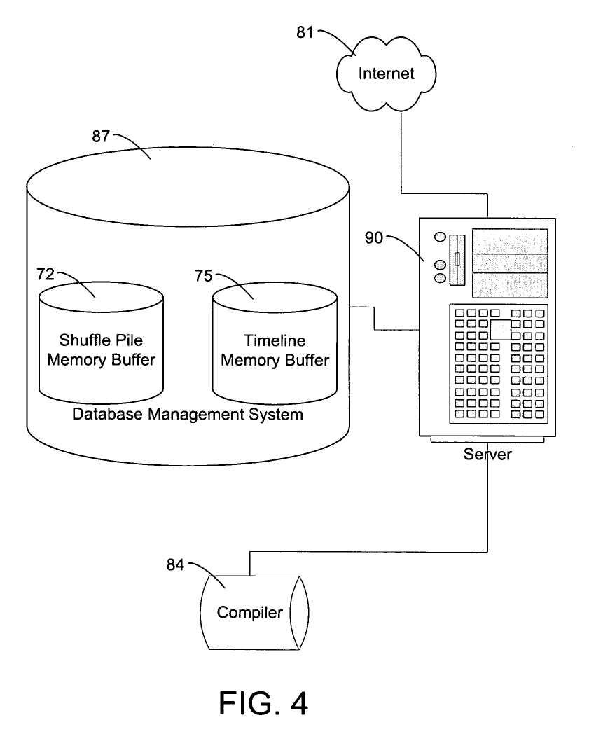

Referring to FIG. 4, a server component of a presently preferred embodiment includes a database management system 87. The database management system 87 includes two subset databases, a shuffle pile memory buffer 72 and a timeline memory buffer 75, each being configured as set forth in the discussion of the components laid out with respect to FIG. 3 above. The database management system 87 moves items of media content into and out of the shuffle pile memory buffer 72 and the timeline memory buffer 75 based upon instructions from a server stub 90 in operative communication with the database management system 87.

The server stub 90, communicates with remote computers including a client computer 11a, b, or c (FIG. 1) over a network such as the Internet 81. The client computer 11a, b, or c (FIG. 1) communicates with the server stub 90 to compose the multimedia presentation by suitable movement of media items into the timeline buffer system 75 according to user interactions with an indicator software 66 (FIG. 3). The server stub 90 then sends messages back to the indicator software 66 (FIG. 3) to facilitate synchronization. In this case, synchronizing means facilitating the indicator software 66 (FIG. 3) to generate a representative display with an actual memory state of each of the shuffle pile memory buffer 72 and a timeline memory buffer 75. By synchronizing the indicator software 66, the server stub 90 delays a need to transfer actual media content to the client computer 11a, b, or c (FIG. 1), until a compiler 84, at the direction of the server stub 90, saves the media content of the timeline memory buffer in a suitable format, according to the associated exposition times.

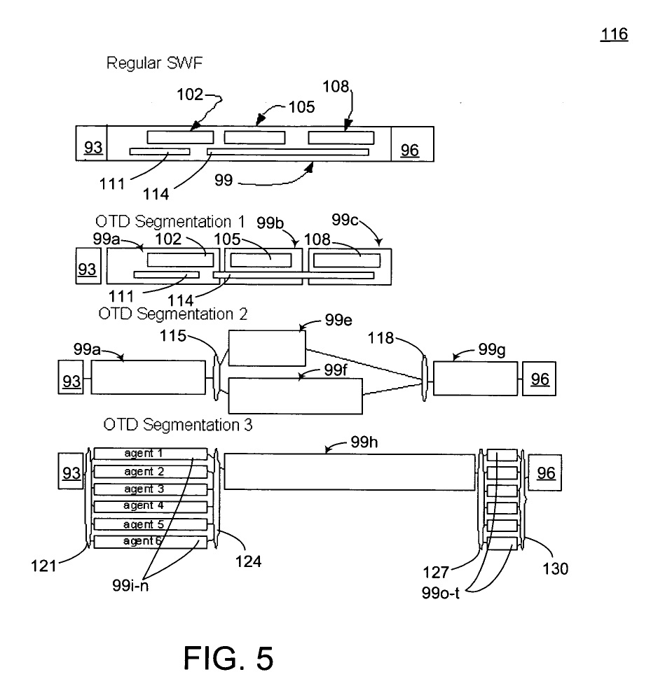

Referring to FIG. 5, comparison of a Shockwave Media File with the series of segments produced by the inventive method suggest a graphic comparison 116a, b, c, and
d. According to the Shockwave Flash (SWF) File Format Specification, Version 7, “[t]he Macromedia Flash file format (SWF) (pronounced “swiff”) delivers vector graphics and animation over the Internet to the Macromedia Flash Player. The SWF file format is designed to be a very efficient delivery format, not a format for exchanging graphics between graphics editors.” The files are in a tagged format, including a header known as a resource reservation header 93 and a series of tagged data blocks. The resource reservation header 93 includes information as to the length and graphic rendition quality of a movie the file contains, thereby reserving such resources as would be necessary to show the Shockwave Flash movie.

There are two categories of tags in SWF:
Definition Tags that define the content of the SWF movie—the shapes, text, bitmaps, sounds, and so on. Each definition tag assigns a unique ID called a character ID to the content it defines. Flash Player then stores the character in a repository called the dictionary. Definition tags, by themselves, do not cause anything to be rendered.
Control Tags These tags create and manipulate rendered instances of characters in the dictionary, and control the flow of the movie.

Flash Player processes all the tags in a SWF file until a ShowFrame tag is encountered. At this point, the display list is copied to the screen and Flash Player is idle until it is time to process the next frame. The contents of the first frame are the cumulative effect of performing all the control tag operations before the first ShowFrame tag. The contents of the second frame are the cumulative effect of performing all the control tag operations from the beginning of the file to the second ShowFrame tag, and so on.

Referring, then, to graphic depiction 116a, in an unmodified Shockwave Flash movie, frames are generally, though not necessarily arranged in temporal order. Where they are arranged in temporal order, media items are arranged in a file in a manner corresponding to the media content 99. Thus, a header 93 and a end tag 96 are evident. Photographs are rendered by ShowFrame tags grouped to represent media so that a first photograph 102 is displayed, then a second photograph 105, and a third photograph 108. Similarly, an audio track consisting of two sound bites, a first sound bite 111 and a second sound bite 114 are similarly depicted in association with their exposition times.

Because the unmodified Shockwave Flash file includes a series of discrete frames, each rendered and exhibited at the invocation of a ShowFrame tag, segmenting the portions of the media content 99 at the ShowFrame tags will do no violence to the media content contained therein. The inventive method adds both security and a determinate, configurable order to the presentation of media content by segmenting Shockwave Flash files. The ability to change the resource reservation header 93 along with the facility to segment files are sufficient attributes to allow the determination of the order of the media content presentation.

Thus, referring to graphic depiction 116b of a segmented file according to the inventive method, the content is suitably intact. As the Shockwave File Specification will continue to play a defined sound bite for as long as the tag designates, the occurrence of a ShowFrame tag will not terminate the rendering of the audio bit. Thus, upon segmentation of the media content 99 into segments 99a, b, and c, no discernable difference is noted by an auditor of the Shockwave Flash file in spite of the segmentation of the media content.

Where the Shockwave Flash file is then augmented with distinct segments defined by the ShowFrame tags, and the resource reservation header 93 is modified to dictate a modified order of exposition, a graphic depiction 116c shows logical branching possible in due to the inventive segmentation of the media files. Where the resource reservation header 93 dictates the rendering and exposition of a segment of media content 99f rather than the segment 99e, the auditor of the modified Shockwave Flash movie, will perceive the modified Shockwave Flash movie shown as graphic depiction 116c as a single integral but distinct Shockwave Flash movie branching and reuniting at ShowFrame Tags 115 and 118 respectively.

The ability to train distinct segments of media content, 99a, 99e, 99f, and 99g into a movie with the prepending of the modified resource reservation header 93 allows for flexibility and uniformity in the composition of multimedia presentations. Referring to the graphic depiction 116d, a “fill in the blanks” template of a multimedia show is configurable by a user. Where a user wishes to produce numerous multimedia productions with a similar “look and feel,” a user designs a template production, as depicted by graphic depiction 116a, choosing to define segments at suitable ShowFrame tags as to make a segmented file as depicted in graphic depiction 116d. The resource reservation header can then be modified to designate distinct movies such as a movie comprising media content 99i, with rendered and displayed at a ShowFrame tag 124, showing common media content 99h, and then branching again at the ShowFrame tag 127 to one of a plurality of media content 99o-t, reuniting at a ShowFrame tag 130 to end at the end tag 96.

An example of a user might be a real estate brokerage where a premium is placed on a common “look and feel” in marketing the brokerage. Each real estate agent might have a distinct introductory presentation such as 99n for agent 6. The brokerage might wish to then explain the reasons for using it over other such brokerages in the market area, so media content 99h is displayed, and then, finally, a subject property might be presented in a media content 99q. The end tag 96 instructs the player to terminate the movie. The common “look and feel” of the brokerage presentation is preserved much as stationery preserves a “look and feel” for correspondence from the brokerage.

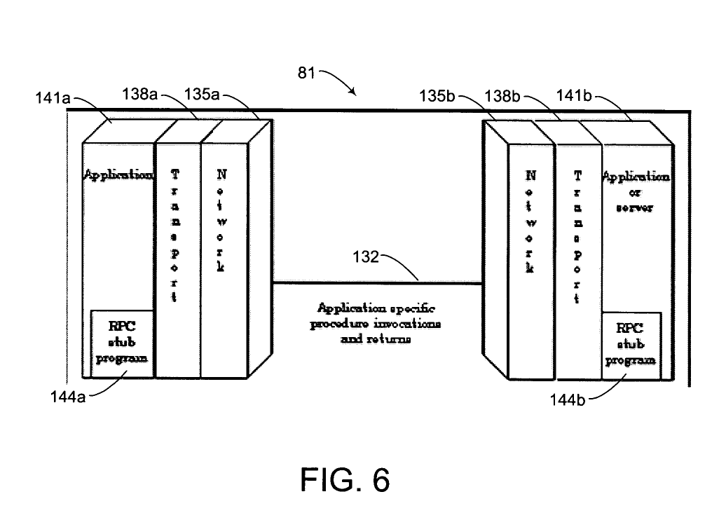

While any suitable network protocol will work to facilitate the communication between the indicator software 66 and the memory bus 69 (FIG. 3), a remote procedural call architecture is employed in the presently preferred embodiment. Referring to FIG. 6, in order to access the remote server portion of an application 141b, the client portion of the application 141a places special function calls or remote procedure calls (RPCs), according to a protocol embedded within the client portion of the application program 141a. Because they are embedded, RPCs do not stand alone as a discreet middleware layer and thus the calls can be configured to the application set 141a and b. Such transport functions as are necessary are handled by code on the client side 138a allowing access to the client network portal 135a and allowing the server network portal 135b to communicate through the server transport software 138b to the server side application 141b. When the client program is written, the software designer places the embedded protocols in the source code by means of a local stub for the client portion 144a and another stub for the server portion 114b of the application. These stubs are invoked when the application requires a remote function and typically support synchronous calls between clients 11 and servers 7 (FIG. 1).

By using RPCs, the flexibility of architecture is enhanced by allowing a client component of an application 141a to employ a function call to access a server on a remote system. RPC allows the remote server application 141b to be accessed without knowledge of the network address or any other lower-level information. Most RPCs use a synchronous, request-reply (sometimes referred to as “call/wait”) protocol that involves blocking of the client until the server fulfills its request. Asynchronous (“call/nowait”) implementations are available but are currently the exception.

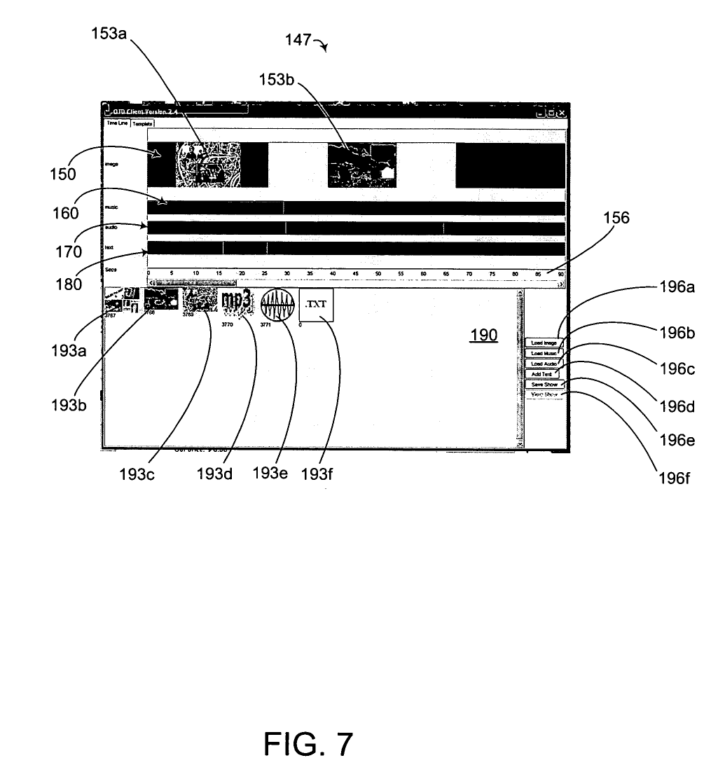

Referring to FIG. 7, a client side application screen shot 147, portrays a graphic depiction 148 of the timeline memory buffer 75 (FIGS. 3, 4) consisting, in this embodiment of four discrete channels, a visual channel 150, a music channel 160, an audio channel 170, and a text channel 180. Additionally, a temporal scale 156 is aligned with the channels in order to display the association media content in the timeline memory buffer 75 by alignment between icons generated to indicate media content such as a first photo icon 153a and a second photo icon 153b.

Beneath the graphic depiction 148 of the timeline memory buffer is a graphic depiction of the contents of the shuffle pile memory buffer 190. In the graphic display of the shuffle pile memory buffer 190, various media icons representative of media content stored in the shuffle pile memory buffer 72 (FIGS. 3, 4) are shown. A third photo icon 193a, a fourth photo icon 193b, and a fifth photo icon 193c are available in the shuffle pile memory buffer 72 for insertion into the multimedia program by placement into the photo channel 150. Similarly, a music icon 193d, and an audio icon 193e are available for positioning in the music and audio channels, 160 and 170 respectively. Finally, a text icon 193f is also present for suitable placement in the text channel. Pushbutton 196a allows a user to add images to the shuffle pile from a local hardrive, as does pushbutton 196b for music, 196c for audio, and 196d for text. A pushbutton 196e allows the contents of the timeline shuffle pile memory buffer 75 as represented in the graphic depiction 148 to be compiled into a Shockwave Flash file. While currently grayed out in this FIG. 7, once a Shockwave Flash file is compiled, a pushbutton 196f allows the viewing of the compiled Shockwave Flash file.

An author may construct a Shockwave Flash file by simply dragging and dropping the icons into the appropriate channel for containing the media content. Associations between the media content and the exposition times can be adjusted by “dragging” borders of the icon with the mouse 63 (FIG. 3) to move the content relative to the time scale 156 in order shift those associations.

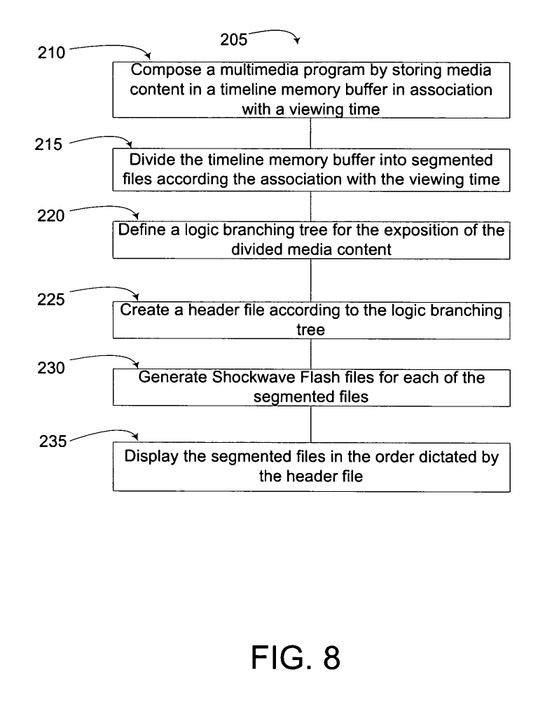

Referring to FIG. 8, a method for composing a multimedia program 205, a user composes a multimedia program by storing media content in a timeline memory buffer in association with an exposition time at a block 210. The presently preferred method for composition is described herein. The presently preferred embodiment composes a Shockwave Flash file but Scalable Vector Graphics or equivalent file format specifications will work equally well.

Once the full Shockwave Flash file is completely compiled, divide the segmented files according to the association with viewing times resulting in a plurality of files. Shockwave Flash files are suitably divided into segment files at a block 215.

At a block 220, a sequence for displaying segmented files is designated. The sequence designation may be by means of programming, interaction with a user or interaction with a final user. One means of sequence designation is by means of interaction between a user and a software component. Another means is by interaction between an auditor and a client machine. Logical branching in either instance will work to determine a sequence for exposition. At a block 230, a resource reservation header is generated according to the logical branching.

At a block 235, a player shows the resulting sequence of shockwave movies in accord with the resource reservation header.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A computer software program stored on a computer readable medium and configured to assist a user in composing multimedia programming, the program comprising:
a user interface, the user interface including:
an indicator for interaction with a user, the indicator configured for movement of files by identifying designated files and further by identifying a designated memory buffer for storing the designated file;
a timeline memory buffer, the timeline memory buffer being configured to receive designated media content in association with selected times of exposition;
a shuffle pile memory buffer configured to hold media content as available for optional transfer to the timeline buffer; and
a read/write director for retrieving designated files and storing them in the designated memory buffer according to the indicator.
a compiler configured to generate at least one file for storage on computer-readable medium, the file being in a format configured for display and generated according to the in the media content and associations in the timeline buffer.

2. The computer software program of claim 1, wherein the format is shockwave flash.

3. The computer software program of claim 1, wherein the shuffle pile memory buffer is located on a server.

4. The computer software program of claim 3, wherein the media content stored in the shuffle pile memory buffer includes protected media content associated with purchasable licenses for use.

5. The computer software program of claim 4, wherein the compiler is further configured to facilitate user purchase the associated license, when the protected media content is included in a file the compiler generates.

6. The computer software program of claim 1, wherein the user interface includes a store memory buffer, the store memory buffer being located on a server in a computer network, the store containing protected media associated with a purchasable license for use.

7. The computer software program of claim 6, wherein the compiler is further configured to facilitate user purchase the associated license, when the protected media content is included in a file the compiler generates.

8. The computer software program of claim 1, wherein the user interface includes a local memory buffer configured to accept media from memory storage in operative communication with the user interface.

9. The computer software program of claim 1, wherein the compiler generates a plurality of files and a header, the header configured to designate an exposition order for exposing the files.

10. The computer software program of claim 9, wherein the header is generated by interaction with the user.

11. The computer software program of claim 9, wherein the header is generated to include logical branches, the logical branches being configured to alter the exposition order according to interaction with an auditor.

12. The computer software program of claim 1, wherein the indicator includes a graphic display, the graphic display configured to indicate the contents of the timeline memory buffer and the contents of the shuffle pile memory buffer.

13. The computer software program of claim 12, wherein the graphic display is further configured to indicate placement of media content in the timeline memory buffer by means of placement of icons along at least one temporal scale.

14. The computer software program of claim 13, wherein the at least one temporal scale includes a scale indicative of sound media content.

15. The computer software program of claim 13, wherein the at least one temporal scale includes a scale indicative of voice media content.

16. The computer software program of claim 13, wherein the at least one temporal scale includes a scale indicative of display media content.

17. The computer software program of claim 13, wherein the at least one temporal scale includes a scale indicative of display text media content.

18. A computer software program stored on a computer readable medium in operative communication with a server on a network, the program configured to generate multimedia presentations, the program comprising:
a database management system, the database management system comprising:
a timeline memory buffer for storing a multimedia presentation, the timeline memory buffer configured to store media content in association with an exhibition time within the multimedia presentation;
a server stub, the server stub configured for:
storing and recalling data in the database management system in response to requests for actions received at the server stub from a client computer by means of operative communication through a network; and
generating messages sent to the client computer indicative of the media content stored in the timeline memory buffer; and
a compiler, the compiler configured to generate a movie file comprising the multimedia presentation stored in the timeline memory buffer.

19. The computer software program of claim 18, wherein the movie file is a shockwave flash movie file.

20. The computer software program of claim 18, wherein the database management system includes a store memory buffer, the store memory buffer containing protected media content associated with purchasable licenses for use.

21. The computer software program of claim 20, wherein the compiler is further configured to facilitate user purchase the associated license, when the protected media content is included in a file the compiler generates.

22. The computer software program of claim 18, wherein the messages are configured to allow a client computer to generate a graphic display.

23. The computer software program of claim 22, wherein the graphic display includes icons associated the media content, the icons being configured to indicate a nature of the media content.

24. The computer software program of claim 23, wherein the graphic display is further configured to indicate placement of media content in the timeline memory buffer by means of placement of icons along at least one temporal scale.

25. The computer software program of claim 23, wherein the at least one temporal scale includes a scale indicative of sound media content.

26. The computer software program of claim 23, wherein the at least one temporal scale includes a scale indicative of voice media content.

27. The computer software program of claim 23, wherein the at least one temporal scale includes a scale indicative of display media content.

28. The computer software program of claim 23, wherein the at least one temporal scale includes a scale indicative of display text media content.

29. The computer software program of claim 18, wherein the database management system includes a shuffle pile memory buffer, the shuffle pile memory buffer configured to receive media content and to hold media content to be accessible to a user for movement into the timeline buffer.

30. The computer software program of claim 29, wherein a graphic user interface is configured to indicate the media content held in each of the timeline memory buffer and the shuffle pile memory buffer.

31. A method for compiling and exhibiting a series of files, based upon a multimedia program file, the method comprising:
dividing the content of the multimedia program file into a plurality of segment files based upon a temporal association;
generating a header file that includes an order of the segment files for exhibition;
generating a shockwave flash data file to correspond with each of the plurality of segment files; and
exhibiting the shockwave flash data files according to the order of the segment files.

32. The method of claim 31, wherein the generating a header file includes generating a header file based upon decisions of a user to include media content.

33. The method of claim 31, wherein generating a header file that includes logical branching, the logical branching configured to include media content according to selections made by an auditor.

34. The method of claim 31, wherein the logical branching includes logical branching, the logical branching configured to selectively exhibit media content according to the presence of an external flag.

35. The method of claim 31, further including defining a multimedia program, the multimedia program comprising media content stored in a shuffle pile memory buffer.

36. The method of claim 35, further comprising generating a graphic representation of the temporal association for media content stored in a shuffle pile memory buffer.

37. The method of claim 36, wherein:
the media content is represented by icons, the icons being configured to indicate a nature of the media content; and
the temporal association is represented by placement of the icons on a timeline, the timeline configured to represent the duration of the multimedia presentation.

38. A computer software program, for composing a multimedia program contained in shockwave flash format, the program comprising:
a second component for dividing the content of the multimedia program file into a plurality of segment files based upon a temporal association;
a third component for generating a header file that includes an order of the segment files for exhibition;
a fourth component for generating a shockwave flash data file to correspond with each of the plurality of segment files; and
a fifth component for exhibiting the shockwave flash data files according to the order of the segment files.

39. The computer software program of claim 38, wherein the third component further includes generating a header file based upon decisions of a user to include media content.

40. The computer software program of claim 38, wherein the third component further includes generating a header file that includes logical branching, the logical branching configured to include media content according to selections made by an auditor.

41. The computer software program of claim 38, wherein the logical branching includes logical branching, the logical branching configured to selectively exhibit media content according to the presence of an external flag.

42. The computer software program of claim 38, further including a first component configured for defining a multimedia program, the multimedia program comprising media content stored in a shuffle pile memory buffer.

43. The computer software program of claim 42, wherein the first component further comprises generating a graphic representation of the temporal association for media content stored in a shuffle pile memory buffer.

44. The computer software program of claim 43, wherein:
the media content is represented by icons, the icons being configured to indicate a nature of the media content; and
the temporal association is represented by placement of the icons on a timeline, the timeline configured to represent the duration of the multimedia presentation.

45. A processor for compiling a series of files for transmission across a network, based upon a multimedia program file contained in shockwave flash format, the program comprising:
a second component for dividing the content of the multimedia program file into a plurality of segment files based upon a temporal association;
a third component for generating a header file that includes an order of the segment files for exhibition;
a fourth component for generating a shockwave flash data file to correspond with each of the plurality of segment files; and
a fifth component for exhibiting the shockwave flash data files according to the order of the segment files.

46. The processor of claim 45, wherein the third component further includes generating a header file based upon decisions of a user to include media content.

47. The processor of claim 45, wherein the third component further includes generating a header file that includes logical branching, the logical branching configured to include media content according to selections made by an auditor.

48. The processor of claim 45, wherein the logical branching includes logical branching, the logical branching configured to selectively exhibit media content according to the presence of an external flag.

49. The processor of claim 45, further including a first component configured for defining a multimedia program, the multimedia program comprising media content stored in a shuffle pile memory buffer.

50. The processor of claim 45, wherein the first component further comprises generating a graphic representation of the temporal association for media content stored in a shuffle pile memory buffer.

51. The processor of claim 45, wherein:
the media content is represented by icons, the icons being configured to indicate a nature of the media content; and
the temporal association is represented by placement of the icons on a timeline, the timeline configured to represent the duration of the multimedia presentation.
